(19) United States
(12) Patent Application Publication
(10) Pub. No.: US 2017/0034200 A1
(43) Pub. Date: Feb. 2, 2017

(54) Flaw Remediation Management

(71) Applicant: Federal Reserve Bank of Atlanta, Atlanta, GA (US)

(72) Inventors: Thomas W. Costin, Decatur, GA (US); Ian Wolff, Lake Worth, FL (US); Phillip D. Hall, Johns Creek, GA (US)

(21) Appl. No.: 14/813,662

(22) Filed: Jul. 30, 2015

(51) Int. Cl. H04L 29/06; G06F 21/55; G06F 17/30

(52) U.S. Cl. CPC H04L 63/1433; G06F 17/30598; G06F 17/30914; G06F 17/3053; G06F 21/552

(57) ABSTRACT

A flaw remediation management server (herein ‘flaw server’) receives flaw data from a plurality of flaw sources. Further, the flaw server analyzes and correlates the flaw data to generate one flaw record per flaw for each asset. Furthermore, the flaw server prioritizes the flaw records and stores them in a flaw database along with additional information associated with each flaw record. Then, the flaw server groups the flaw records of the flaw database into one or more work items based on grouping criteria. Further, the flaw server calculates and assigns a work priority score to each work item. Responsively, the flaw server generates instructions to create, update, and/or cancel a remediation ticket for each work item based on the work priority score. Furthermore, the flaw server generates interactive flaw remediation reports and/or dashboards based on the flaw records for presentation to a user.

### TECHNICAL FIELD

Embodiments of the present disclosure relate generally to information technology system security, and more particularly to flaw remediation management.

### BACKGROUND

Flaws in an enterprise's IT system expose the enterprise to various security risks that may prove fatal to the operation of the enterprise. Therefore, identifying and addressing such flaws prior to a security event may be vital to successful operation of the enterprise.

Conventional systems, such as Security information and event management (SIEM) systems, are configured to react to a security event once the security event has occurred. However, these conventional systems take a reactive rather than a proactive approach to IT system security and they fail to prevent security events from occurring. Responding to the security events once they have occurred may prove to be more costly to the enterprise than to identify and respond to flaws that expose the enterprise's IT system to the security events.

Accordingly, in addition to the conventional systems that are configured to address security events, enterprises may use security flaw identification tools to monitor assets associated with the enterprise's IT system and to identify flaws in the assets to prevent security events. However, an increase in the number of these tools for flaw identification, each of which uses a format that is specific to the respective tool to represent the identified flaw, has made it difficult to design an efficient flaw remediation system and/or to efficiently manage the flaw remediation system.

Conventional flaw remediation systems may exist. However, these conventional flaw remediation systems may not be configured to efficiently handle data from the numerous flaw identification tools. For example, the conventional flaw remediation systems may fail to identify the representation of a flaw in different forms by different flaw identification tools. Such failure may result in remediation efforts being overlapped and duplicated resulting in added cost and time to the enterprise. Further, the conventional flaw remediation systems may be configured to individually evaluate flaws within a specific asset, rather than from a more holistic or comprehensive enterprise view. Without the holistic or comprehensive view, the enterprise may be unable to obtain an overall risk and performance status of the enterprise's IT system. Furthermore, the numerous flaw identification tools may result in the generation of large amount of data which may be overwhelming for the conventional flaw remediation systems to analyze and handle. The above-mentioned problems may be further exacerbated as the number of IT assets utilized by an enterprise grows at a rapid pace because the amount of data generated by numerous flaw identification tools would further grow at a significantly faster pace.

Additionally, the conventional flaw remediation systems may be of no value or little value in determining the level of compliance with enterprise security policy and/or regulatory policy. Also, the conventional flaw remediation systems may provide little ability to accurately track remediation attempts. Therefore, there is a need for a technology that overcomes the above-mentioned deficiencies.

### SUMMARY

The present disclosure can address the above-mentioned deficiencies by use of a system, apparatus, and method for flaw remediation management. The flaw remediation management system of the present disclosure is directed towards solving a technical problem of security in information technology systems by providing an efficient and effective way to correlate, manage, and address flaws identified by a plurality of disparate flaw identification and/or information tools/sources from the same vendor and/or different vendors. That is, the flaw remediation management system of the present disclosure promotes seamless interoperability of different flaw identification tools to enhance security of an information technology system. Further, the flaw remediation management system of the present disclosure provides an extensible/scalable system to which any appropriate number of disparate flaw identification tools, both public and proprietary, may be added at any given time. An ability to use any appropriate number of disparate flaw identification and information tools/sources, both public and proprietary, aids the enterprise to identify as many flaws as possible, effectively reflect an owner's risk criteria, and prevent probable security attacks. Thus, the flaw remediation management system of the present disclosure indirectly aids in reducing the points of security attack and the probability of security attack on an enterprise's information technology system by allowing the enterprise to effectively correlate and use disparate flaw identification and/or information tools/sources.

In an example embodiment, a flaw remediation management system includes a flaw remediation management server that receives flaw data from a plurality of discrete flaw identification sources. The flaw data may represent one or more flaws associated with one or more assets of an IT system. Once the flaw data is received, the flaw remediation management server may enhance the flaw data with intelligence information from one or more intelligence sources. The intelligence information may include publicly available data and/or proprietary data associated with the assets of the IT system and/or the flaws.

Responsive to receiving the flaw data and/or the intelligence information, using correlation criteria, the flaw remediation management server correlates the flaw data across the plurality of flaw sources to generate one flaw record per flaw for each asset of the IT system. In particular, for each asset of the IT system, the flaw correlation engine analyzes the flaw data to identify data points that represent the same flaw. Upon identifying the data points that represent the same flaw, the flaw correlation engine generates one flaw record for the flaw represented by the data points. For example, flaw data includes data points 1 and 2 generated by a flaw source 1 and a data point 3 generated by a flaw source 2. Continuing with the example, the data points 1, 2, and 3 of the flaw data are associated with a computer_A of an IT system. Further, the data points 1 and 3 represent a first flaw even though they are distinct from each other and they are generated by two different flaw sources, and the data point 2 represents a second flaw. In said example, the flaw correlation engine correlates flaw data to generate a first flaw record identifying the first flaw represented by both the data points 1 and 3, and a second flaw record identifying the second flaw represented by data point 2.

Responsive to generating one flaw record per flaw for each asset, the flaw remediation management server assigns an asset owner and/or an asset stakeholder to each flaw record. Further, for each flaw record, the flaw correlation engine assigns a service provider responsible for remediating the flaw identified by the flaw record. Additionally, the flaw remediation management server calculates a flaw priority score for each flaw record based on criticality criteria. The criticality criteria may include, but is not limited to, information associated with the criticality of a flaw and/or the criticality of an asset. For example, the criticality criteria may include scores assigned to a flaw by a flaw source and/or an intelligence source that quantifies a risk associated with the flaw, and a criticality score associated with an asset related to the flaw.

Responsive to generating the flaw priority score and assigning flaw record information (asset owner, stakeholder, and/or service provider) to each flaw record, the flaw remediation management server stores the flaw records in a flaw database along with the flaw priority score and/or the flaw record information. Then, using data stored in the flaw database, the flaw remediation management server generates an interactive flaw remediation management report and/or dashboard for presentation to a user. Then, the flaw remediation management server may customize the data presented in the interactive flaw remediation management report and/or dashboard based on an access-level or role of the user. In one example embodiment, the interactive flaw remediation management report and/or dashboard may provide various risk and performance metrics associated with the flaw remediation management system. However, in other example embodiments, the interactive flaw remediation management report and/or dashboard may provide any other appropriate information associated with any component of the flaw remediation management system.

In addition to generating the interactive flaw remediation management report and/or dashboard, the flaw remediation management server retrieves the flaw records stored in the flaw database and groups them into one or more work items. The grouping may be based on grouping criteria such that each work item may include one or more flaw records associated with flaws that can be remediated together. For example, the grouping criteria may include grouping flaw records assigned to one service provider into one work item. Alternatively, in another example, grouping criteria may include grouping flaw records representing the same flaw on a plurality of assets into one work item. One of ordinary skill in the art can understand and appreciate that the grouping criteria examples provided above are not limiting. That is any other appropriate grouping criteria may be used without departing from a broader scope of the present disclosure.

Once the flaw records are grouped into one or more work items, the flaw remediation management server calculates a work priority score for each work item based on the flaw priority score of each flaw record in the respective work item. In some example embodiments, other factors, such as a length of time that a flaw has existed on an asset, a recurrence of the flaw, etc., may be used in addition to or instead of the flaw priority score to calculate the work priority score without departing from a broader scope of the present disclosure.

Responsive to calculating the work priority score, the flaw remediation management server compares the work priority score of each work item to a threshold score. If the work priority score is greater than or equal to the threshold score, the work correlation engine checks the flaw database to determine if a previous flaw remediation ticket was generated for the flaw records included in the work item. If a previous flaw remediation ticket was generated, then, the flaw remediation management server updates the existing flaw remediation ticket to reflect a current status of the flaw remediation ticket. If not, a new flaw remediation ticket is generated for the work item. However, if the work priority score of the work item is below a threshold score, the flaw remediation management server checks the flaw database to determine if a previous flaw remediation ticket was generated for the flaw records included in the work item. If a previous remediation ticket was generated, then, the flaw remediation management server cancels the previous flaw remediation ticket. If not, the flaw remediation management server waits till the work priority score of the work item is greater than the threshold score.

Further, the flaw remediation management server updates the flaw database to indicate that a flaw remediation ticket has been generated, an existing flaw remediation ticket has been updated, or a flaw remediation ticket has been cancelled. In one example embodiment, the flaw remediation management server operates in conjunction with a ticketing system to indirectly generate, update, and/or cancel flaw remediation tickets associated with a work item. That is, the flaw remediation management server may generate application program interface (API) calls requesting the ticketing system to generate, update, and/or cancel flaw remediation tickets associated with a work item. Alternatively, in another example embodiment, the flaw remediation management server may directly generate, update, and/or cancel flaw remediation tickets associated with a work item. In either case, in addition to generating, updating, and/or canceling flaw remediation tickets, the flaw remediation management server may be configured to notify a user regarding the remediation tickets, escalate the flaw remediation tickets when necessary, and/or remind a user (e.g., service provider) regarding the flaw remediation tickets based on service level agreements.

These and other aspects, features, and embodiments of the disclosure will become apparent to a person of ordinary skill in the art upon consideration of the following brief description of the figures and detailed description of illustrated embodiments.

### BRIEF DESCRIPTION OF THE FIGURES

Example embodiments are illustrated by way of example and not limitation in the figures of the accompanying drawings, in which:

FIG. 1 illustrates an example operating environment of a flaw remediation management system in accordance with an example embodiment;

FIG. 2 illustrates example flaw sources associated with the flaw remediation management system of FIG. 1 in accordance with an example embodiment;

FIG. 3 illustrates a block diagram of the flaw remediation management server of FIG. 1 in accordance with an example embodiment;

FIG. 4 is a flowchart that illustrates an example method of operation of the flaw remediation management server of FIG. 1 in accordance with an example embodiment;

FIG. 5 is a flowchart that illustrates an example method of analyzing and correlating flaw data from a plurality of flaw sources to generate one flaw record per flaw per host asset in accordance with an example embodiment;

FIG. 6 is a flowchart that illustrates an example method of managing flaw remediation tickets associated with each work item in accordance with an example embodiment;

FIG. 7 illustrates an example flaw remediation management dashboard in accordance with an example embodiment; and

FIG. 8 illustrates an example flaw remediation management report associated with the flaw remediation management in accordance with an example embodiment.

The elements and features in the drawings are not necessarily to scale; emphasis is instead being placed upon clearly illustrating the principles of example embodiments of the flaw remediation management system. Moreover, certain dimensions may be exaggerated to help visually convey such principles. In the drawings, reference numerals designate like or corresponding, but not necessarily identical, elements throughout the several views.

### DETAILED DESCRIPTION OF EXAMPLE EMBODIMENTS

In the following paragraphs, a system, apparatus, and method for flaw remediation management will be described in further detail by way of examples with reference to the attached drawings. Before discussing the embodiments directed to the system, apparatus, and method for flaw remediation management, it may assist the reader to understand the various terms used herein by way of a general description of the terms in the following paragraphs. However, in the description, well known components, methods, and/or processing techniques are omitted or briefly described so as not to obscure the disclosure. Further, as used herein, the “present disclosure” refers to any one of the embodiments of the disclosure described herein and any equivalents. Furthermore, reference to various feature(s) of the “present disclosure” is not to suggest that all embodiments must include the referenced feature(s) or that all embodiments are limited to the referenced feature(s).

The term ‘flaw identification tools’ as used herein may generally refer to any appropriate hardware and/or software that monitors, identifies and/or assesses flaws in one or more assets of an IT system, e.g., host systems, host system applications, and/or their corresponding networks of the IT system. The different types of flaw sources described herein may include, but are not limited to, configuration flaw identification sources, patch flaw identification sources, and vulnerability identification sources. Hereinafter, the term ‘flaw identification tools,’ may be may interchangeably be referred to as ‘flaw identification sources,’ ‘flaw identification computers,’ or ‘flaw sources’.

The term ‘flaw intelligence source’ as used herein may generally refer to information sources that provide information associated with IT assets and/or flaws associated with the IT assets. Example flaw intelligence sources may include, but are not limited to, threat intelligence sources, Governance Risk and Compliance (GRC) sources, Dynamic Host Configuration Protocol (DHCP) log sources, DHCP Reservation sources, asset inventory database (Configuration Management Database (CMDB)), and so on.

The term ‘flaw’ as used herein may generally refer to any appropriate vulnerability that affects an asset of an IT system and introduces a security risk in the asset of an IT system or exposes the asset to a threat actor. The term ‘vulnerability’ as used herein may generally refer to any appropriate defect that introduces a security risk in an asset of the IT system. When vulnerability is identified as affecting an asset, the relationship may be referred to as a flaw. Example vulnerabilities may include, but are not limited to, software bugs, configuration issues, missing patches, outdated patches, etc. Vulnerabilities may be remediated by application of a software patch or a changing a configuration (OS or network) of an asset. The above-mentioned vulnerability remediation techniques may not be limiting. That is, any other vulnerability remediation techniques may be substituted without departing from a broader scope of the present disclosure.

The term ‘asset’ as used herein may generally refer to any appropriate hardware and/or software component of the information technology system. For example, the asset can be as granular as a CPU chip or a code library, or as broad as a single physical or virtual workstation, printer, server, etc., or a software line. Hereinafter, the term ‘asset’ may be interchangeably referred to as ‘IT asset’.

The term ‘flaw record’ as used herein may generally refer to any appropriate data record that represents and/or identifies a flaw. Further, the term ‘work item’ as used herein may generally refer to one or more flaws that may be remediated together. Alternatively, the term work item may generally refer to a set of flaw records, where the flaws represented by the flaw records may be remediated together. For example, flaw records 1, 2, and 3 may represent flaws 1, 2, and 3 respectively. In said example, the flaws 1, 2, and 3 may be remediated together and accordingly, the flaw records 1, 2, and 3 may be grouped as one work item.

The term ‘remediation’ as used herein may generally refer to any appropriate act of correcting a vulnerability. In other words, remediation refers to correcting a flaw in an asset of an IT system.

The term ‘asset owner’ as used herein may generally refer to a business or a person who owns an IT asset. The asset owner may be accountable for any appropriate risk associated with the IT asset. The term ‘service provider’ as used herein may generally refer to a party responsible for maintaining an IT asset. In some example embodiments, the service provider may be delegated by the asset owner. Further, the term ‘stakeholder’ as used herein may generally refer to any informed third party who has security interest in an IT asset but does not own or maintain the IT asset. For example, the stakeholder may be a business partner or a customer.

In an exemplary embodiment, a flaw remediation management server receives flaw data from a plurality of discrete flaw sources. The flaw data may include a plurality of data points, each data point representative of a flaw associated with an IT asset and identified by a respective flaw source. Upon receiving the flaw data, the flaw remediation management server analyzes and correlates the flaw data to generate one flaw record per flaw for each IT asset using correlation criteria. Once the flaw records are generated, the flaw remediation management server generates a flaw priority score for each flaw record using criticality criteria. Additionally, the flaw remediation management server assigns an asset owner, a stakeholder, and a service provider to each flaw record. Responsive to generating the flaw priority score and assigning the asset owner, the stakeholder, and the service provider to each flaw record, the flaw remediation management server stores the flaw records in a flaw database along with at least the flaw priority score associated with each flaw record, and information associated with the asset owner, the stakeholder, and/or the service provider. Further, using data stored in the flaw database, the flaw remediation management server creates an interactive flaw remediation management report and/or dashboard for view by a user. In particular, the interactive flaw remediation management report may be customized for the user based on a role of the user and/or an access-level of the user.

Further, the flaw remediation management server groups the flaw records in the flaw database into work items based on grouping criteria. In particular, each work item may include flaw records that represent flaws which can be remediated together in one remediation effort. Once the flaw records are grouped into work items, the flaw remediation management server generates a work priority score based on the flaw priority scores of each flaw record in the work item. Then, the work priority score of each work item is compared to a threshold score to cause a generation of a new flaw remediation ticket, an update of an existing flaw remediation ticket, and/or a cancellation of a flaw remediation ticket. That is, the flaw remediation management server manages flaw remediation tickets based on the work priority score.

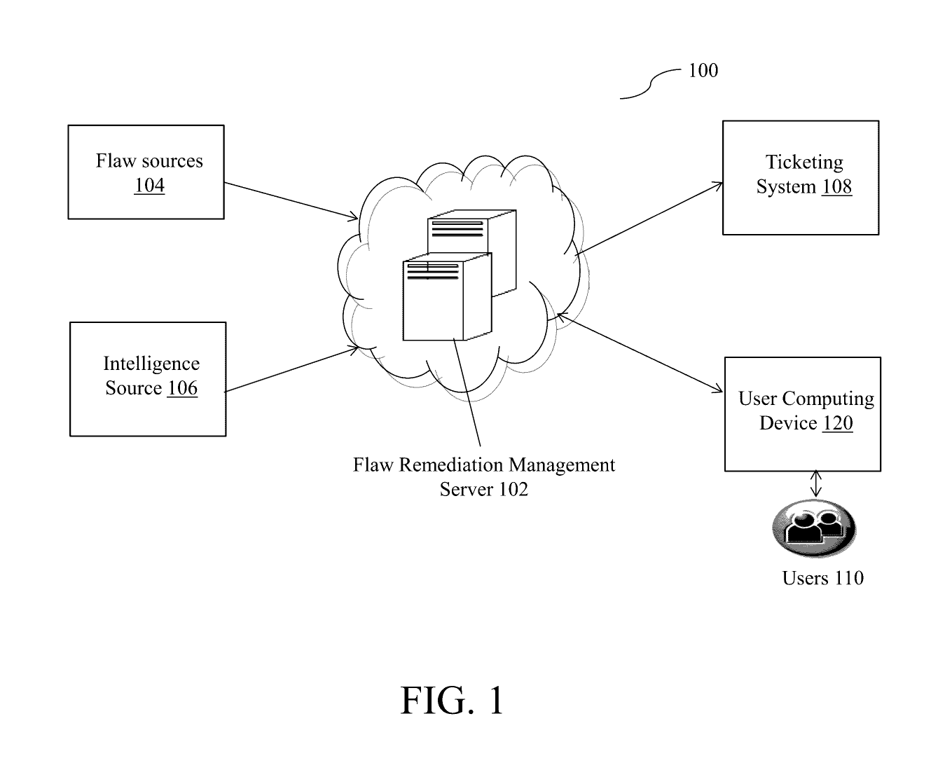

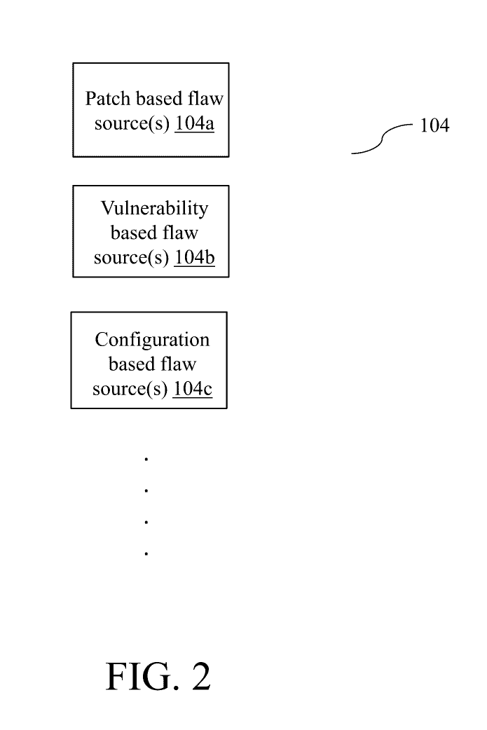

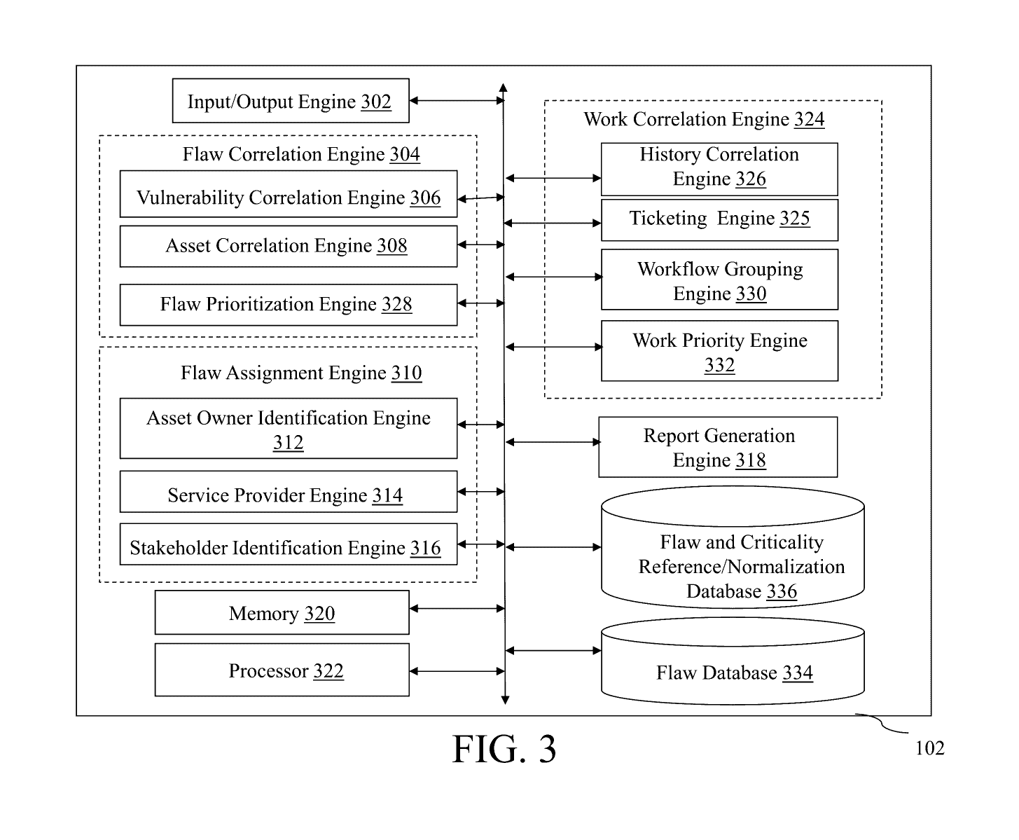

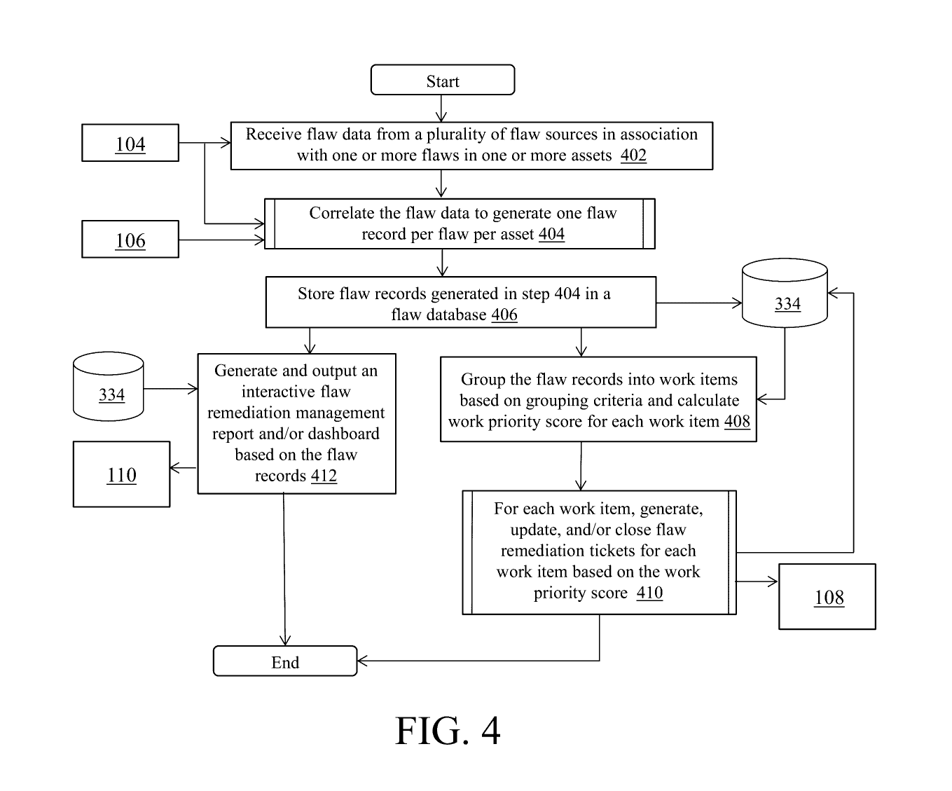

Technology associated with the system, apparatus, and method for flaw remediation management will now be described in greater detail with reference to FIGS. 1-8, which describe representative embodiments of the flaw remediation management system. First, FIG. 1 will be discussed in the context of describing a representative operating environment associated with the flaw remediation management system according to certain exemplary embodiments of the present invention. FIGS. 2 and 3 will be discussed, making exemplary reference back to FIG. 1 as may be appropriate or helpful. Further, FIGS. 4-8 will be discussed, making exemplary reference back to FIGS. 1-3 as may be appropriate or helpful.

The following paragraphs describe various embodiments of the method, apparatus, and system for flaw remediation management. It will be appreciated that the various embodiments discussed herein need not necessarily belong to the same group of exemplary embodiments, and may be grouped into various other embodiments not explicitly disclosed herein. In the following description, for purposes of explanation, numerous specific details are set forth in order to provide a thorough understanding of the various embodiments.

Moving to FIG. 1, this figure illustrates an example operating environment of the flaw remediation management system in accordance with an example embodiment. In particular, FIG. 1 illustrates a flaw remediation management server 102, a plurality of flaw sources 104, a plurality of flaw intelligence sources 106 (herein referred to as ‘intelligence sources’), a ticketing system 108, and users 110.

As illustrated in FIG. 1, the flaw remediation management system 100 may include a plurality of flaw sources 104 that are communicably coupled to a flaw remediation management server 102 (herein ‘flaw server’) via a private and/or public network over a wired and/or wireless communication link. In particular, the plurality of flaw sources 104 may monitor and/or identify flaws associated one or more IT assets of an enterprise's IT system. Further, the plurality of flaw sources 104 may transmit the identified flaws to the flaw server 102 in the form of flaw data.

In certain example embodiments, the plurality of flaw sources 104 may include commercially available flaw sources; however, in other example embodiments, the plurality of flaw sources may be proprietary flaw sources or flaw sources that are local to an enterprise. Further, in certain example embodiments, the plurality of flaw sources may be categorized into three categories based on the flaws identified by the flaw sources, namely, security patch related flaw sources 104a, vulnerability related flaw sources 104b, and/or configuration related flaw sources 104c as illustrated in FIG. 2. However, one of ordinary skill in the art can understand and appreciate that in some embodiments, the plurality of flaw sources as described herein can include flaw sources that are configured to identify any other appropriate type of flaw without departing from a broader scope of the present disclosure. Example flaw sources may include, but are not limited to, endpoint and patch management solutions (Tivoli Endpoint Manager, Microsoft System Center Configuration Manager, Secunia, Zenworks, Spiceworks, LanDesk, etc), vulnerability scanners (Nessus, NeXpose, IP360, Qualys, etc.), web application scanners (Acunetix, AppScan Rational, Web Inspect), source code scanners (AppScan Source, Fortify, etc.), and configuration and compliance baseline analyzers (Tivoli Endpoint Manager, Microsoft Baseline Security Analyzer, Nessus, etc).

Further, one of ordinary skill in the art can understand and appreciate that the plurality of flaw sources may be disparate flaw sources from different vendors and flaw data from each flaw source may be native to the respective flaw source or may be vendor specific. For example, two flaw sources may be configured to identify the same flaw. In said example, the flaw data from the first flaw source may identify and represent the same flaw in a different form compared to the flaw data from the second flaw source identifying and representing the same flaw. That is, the flaw data from the first flaw source may be specific to the first flaw source or vendor associated with the first flaw source and different from the flaw data from the second flaw source that may be specific to the second flaw source or the vendor associated with the second flaw source. However, in some embodiments, the disparate flaw sources may be from a single vendor and may have a few similarities.

In addition to the plurality of flaw sources 104, the flaw remediation management system 100 may include a plurality of intelligence sources 106 that are communicably coupled to a flaw remediation management server 102 (herein ‘flaw server’) via a private and/or public network over a wired and/or wireless communication link. The plurality of intelligence sources 106 may provide intelligence information to the flaw server 102 to enhance or enrich the flaw data from the plurality of flaw sources 104. Intelligence information may include, but are not limited to, flaw related information, asset related information, security policy and compliance information, and/or information regarding exceptions. Further, the different types of flaw intelligence sources 106 may include, but are not limited to, databases that maintain an updated list of cyber threats, asset information databases, databases that maintain an updated list of exceptions and plan of action Milestones (PoAM's), and so on.

Responsive to receiving the flaw data and/or the intelligence information, the flaw server 102 may analyze and correlate the flaw data across the plurality of flaw sources to generate one flaw record per flaw for each IT asset of the enterprise's IT system. Further, the flaw server 102 groups the generated flaw records into work items using grouping criteria. Furthermore, the flaw server 102 generates a work priority score for each work item and compares the work priority score of each work item with a threshold score. On the basis of the comparison result, the flaw server 102 may operate in conjunction with the ticketing system 108 to generate, update, and/or cancel remediation tickets for remediating flaws associated with flaw records of each work item. For example, the flaw server 102 may generate API calls to invoke an instance of the ticketing system 108 for generating, updating, and/or canceling the remediation tickets. In addition to generating, updating, and/or canceling the work order tickets for remediation of flaws, the flaw server 102 may operate in conjunction with the ticketing system 108 to notify, remind, and/or escalate the work order ticket to appropriate users 110 of the flaw remediation management system 100 based on service level agreements. Accordingly, as illustrated in FIG. 1, the flaw server 102 may be communicably coupled to the ticketing system 108 via a private and/or public network over a wired and/or wireless communication link. However, one of ordinary skill in the art can understand and appreciate that in some example embodiments, the ticketing system may be integral with the flaw server 102.

Further, as illustrated in FIG. 1, the flaw remediation management system 100 may include one or more users 110. The users 110 of the flaw remediation management system 100 may include, but are not limited to, a system administrator, an asset owner, a stakeholder, a service provider, and/or any appropriate employee of the enterprise that uses the flaw remediation management system 100. Further, the users 110 may be communicably coupled to the flaw server 102 via their respective user computing device 120.

In particular, the users 110 may access the flaw server 102 to receive, view, and/or download an interactive flaw remediation dashboard and/or reports generated by the flaw server 102. The interactive dashboard and/or reports may be presented to users 110 that are successfully authenticated by the flaw server 102. Accordingly, the users 110 may communicate with the flaw server 102 via their respective user computing devices 120 to transmit appropriate user credentials to the flaw server 102 for authentication. Responsive to authenticating, the flaw server 102 identifies a role or an access-level associated with the respective user 110. Further, the flaw server 102 customizes the interactive dashboard and/or reports based on the role or an access-level of a user. Responsively, the customized interactive dashboard and/or reports may be presented to the user 110. The operation of the flaw server 102 and the flaw remediation management system 100 will be described in greater detail in association with FIGS. 4-8, and a hardware implementation of the flaw server 102 will be described in greater detail below in association with FIG. 3.

Turning to FIG. 3, this figure illustrates a block diagram of the flaw remediation management server of FIG. 1 in accordance with an example embodiment. In particular, FIG. 3 illustrates an input/output engine 302, a flaw correlation engine 304, a vulnerability correlation engine 306, an asset correlation engine 308, a flaw assignment engine 310, an asset owner identification engine 312, a service provider identification engine 314, a stakeholder identification engine 316, a memory 320, a processor 322, a work correlation engine 324, a ticketing engine 325, a history correlation engine 326, a flaw prioritization engine 328, a workflow grouping engine 330, a work prioritization engine 332, a report generation engine 318, a flaw and criticality reference/normalization database 336, and a flaw database 334.

Although FIG. 3 of the present disclosure illustrates engines 302-318 and databases 334, 336 as being part of the flaw server 102, one of ordinary skill in the art can understand and appreciate that the one or more of the engines 302-318 and databases (334, 336) may be implemented as a separate standalone component that is external to and communicably coupled to the flaw server 102. For example, in some embodiments, the report generation engine 318 and/or the flaw database 334 may not be part of the flaw server 102. Accordingly, in said example embodiments, the report generation engine 318 and/or the flaw database 334 may be implemented as standalone components external to the flaw server 102 and communicably coupled to the flaw server 102.

Further, the flaw server 102 may be implemented using one or more data processing devices, either as a distributed server system where the operations of the flaw server 102 may be distributed between one or more data processors or as a centralized server system where the operations of the flaw server 102 may be handled by a single data processor.

As illustrated in FIG. 3, the flaw server 102 may include a processor 322, where the processor 322 may be a multi-core processor or a combination of multiple single core processors. Further, the flaw server 102 may include a memory 320 coupled to the processor 322. The memory 320 may be non-transitory storage medium, in one embodiment, and a transitory storage medium in another embodiment. The memory 320 may include instructions that may be executed by the processor 322 to perform operations of the flaw server 102. In other words, operations associated with the different engines and/or databases of the flaw server 102 may be executed using the processor 322.

In particular, the flaw server 102 may include an input/output engine 302 that is configured to enable communication to and from the flaw server 102. The input/output engine 302 may receive input from the plurality of flaw sources 104, the plurality of flaw intelligence sources 106, the user computing device 120, and/or the ticketing system 108. Example input received by the input/output engine 302 may include, but is not limited to, flaw data, intelligence information, credentials associated with the user 110 from the user computing device 120, criteria configuration information from the user 110, and/or information from the ticketing system 108. In response to receiving the input, the flaw server 102 may generate one or more outputs for transmission to the plurality of flaw sources 104, the plurality of flaw intelligence sources 106, the user computing device 120, and/or the ticketing system 108 via the input/output engine 302. In particular, the output transmitted by the input/output engine 302 may include, but is not limited to, interactive flaw remediation management reports and/or dashboards, API calls to the ticketing system 108, and/or queries to the plurality of flaw sources 104 and/or flaw intelligence sources 106. Further, in some example embodiments where one or more engines 302-318 or databases (334, 336) of the flaw server 102 are implemented as standalone components external to the flaw source 102, the various inputs and outputs of the flaw server 102 may also include data sent to and/or received from the one or more engines that are external to the flaw server 102.

In one example embodiment, the input/output engine 302 may receive (a) flaw data from the plurality of flaw sources 104 and/or (b) intelligence information from the plurality of intelligence sources 106. In certain example embodiments, the flaw data and/or the intelligence information may be received in response to a query to the plurality of flaw sources 104 and/or intelligence sources 106, whereas, in other example embodiments, the plurality of flaw sources 104 and/or the plurality of intelligence sources 106 may be configured to automatically transmit the flaw data and/or the intelligence information to the input/output engine 302. In either case, upon receiving the flaw data and/or the intelligence information, the input/output engine 302 may forward the flaw data and/or the intelligence information to the flaw correlation engine 304.

As described above, flaw data as used herein may include one or more data points. Each data point represents a flaw identified by a flaw source and includes, inter alia, flaw information associated with the flaw identified by the flaw source and asset information associated with the IT asset related to the identified flaw. In certain example embodiments, each flaw source may have a unique asset identifier that refers to an IT asset and a unique flaw identifier that refers to a flaw or vulnerability, where the unique asset identifier and the flaw identifier may be native to the flaw source. Alternatively, each flaw source may have multiple asset identifiers referring to the same IT asset and multiple flaw identifiers referring to the same flaw or vulnerability. In other words, each flaw source 104 may represent a flaw and its corresponding IT asset using one or more flaw identifiers and asset identifiers that are native to the respective flaw source.

Accordingly, responsive to receiving the flaw data and/or the intelligence information, the flaw correlation engine 304 may analyze and correlate flaws and/or IT assets across each flaw source to produce a single flaw record per flaw for each asset. In particular, first, the asset correlation engine 308 of the flaw correlation engine 304 may normalize asset information from the plurality of flaw sources 104. One of ordinary skill in the art can understand and appreciate that any appropriate normalization techniques, such as regex replace, regex assertions, list splitting and string functions, may be used to normalize the flaw data without departing from a broader scope of the present disclosure.

Responsive to normalizing the asset information, the asset correlation engine 308 may map the normalized asset information to a master list of unique asset identifiers that are native to the flaw server 102 based on mapping criteria. In particular, the normalized asset information may be mapped to the master list of unique asset identifiers using mapping criteria that are configurable by a user 110. The mapping criteria may be configured based on the flaw data, the intelligence information, and/or manually identified relationships between asset identifiers across different flaw sources to associate the asset identifiers that are native to the flaw sources with the asset identifiers that are native to the flaw server 102. A couple of example mapping criteria may be included below:
vulnerability scanner resolved NetBIOS' hostname=endpoint manager ‘computer name’=CMDB ‘item name’, or
If vulnerability scanner ‘ip’=endpoint manager ‘ip’, then endpoint manager ‘computer name’=CMDB ‘item name’.

One of ordinary skill in the art can understand and appreciate that the example mapping criteria provided above is not limiting and that any other mapping criteria may be used to map the normalized asset information to a master list of unique asset identifiers that are native to the flaw server 102 without departing from a broader scope of the present disclosure.

Once asset information is normalized and mapped to the master list of asset identifiers that are native to the flaw server 102, each data point of the flaw data is associated with the master asset identifier native to the flaw server 102. Responsive to associating the data points of the flaw data with the master asset identifiers native to the flaw server 102, the asset correlation engine 308 communicates with the vulnerability correlation engine 306 to normalize and correlate the flaws identified by the data points of the flaw data to generate one flaw record per flaw for each IT asset. In particular, the flaws may be correlated using correlation criteria that are configurable by a user 110, such as a system administrator. That is, the vulnerability correlation engine 306 may identify relationships between flaws identified by each flaw source based on the configurable correlation criteria. In one example, the correlation criteria may be configured based on a Common Vulnerability and Exposure (CVE) identifier, a Microsoft advisory and Knowledge Base identifier, a vendor proprietary identifier, a NIST control number, and/or manually identified relationships between flaw identifiers that are native to their respective flaw sources. However, one of ordinary skill in the art can understand and appreciate that above mentioned example is not limiting and that the correlation criteria may be configured using any other appropriate identifiers and/or factors without departing from a broader scope of the present disclosure.

In one example, flaw data includes a data point 1 that represents a flaw 1 in an asset 1 identified by a flaw source 1, and a data point 2 that represents a flaw 1 in the asset 1 identified by flaw source 2. Continuing with the example, in data point 1, the flaw source 1 represents flaw 1 using a CVE identifier (CVE-yyyy-xxxxx). However, data point 2 generated by flaw source 2 may be a patch released by Microsoft and represented using a Microsoft advisory and Knowledge Base identifier (MSxx-zzzz). In said example, upon correlating the flaw data, the vulnerability correlation engine 306 recognizes that data point 1 and data point 2 represent the same flaw, i.e., flaw 1 using correlation criteria that equates the CVE identifier (CVE-yyyy-xxxxx) and the Microsoft advisory and Knowledge Base identifier (MSxx-zzzz) to flaw 1. That is, CVE-yyyy-xxxxx=MSxx-zzzz=flaw 1. Alternatively, since most flaws can be traced back to a CVE number, the vulnerability correlation engine 306 may trace the Microsoft advisory and Knowledge Base identifier (MSxx-zzzz) back to a CVE number. Then, the vulnerability correlation engine 306 checks to see if the CVE number traced back from the Microsoft advisory and Knowledge Base identifier matches the CVE number in data point 1 from flaw source 1. If the CVE numbers match, the vulnerability correlation engine 306 determines that data point 1 and data point 2 refers to the same flaw, i.e., flaw 1. Accordingly, for asset 1, the vulnerability correlation engine 306 generates one flaw record for flaw 1 even though flaw 1 is represented using two different data points, i.e., data points 1 and 2, thereby eliminating redundancy.

Once the flaw data is correlated to generate one flaw record per flaw for each asset, the flaw prioritization engine 328 may calculate a flaw priority score for each flaw record using criticality criteria that is configured based on one or more factors such as, but not limited to, a criticality of the flaw and/or a criticality of the asset. For example, if computer A associated with the flaw_1 of flaw record_A has a very high asset criticality value and computer B associated with the same flaw_1 of a flaw record B has a moderate asset criticality value, the flaw correlation engine 304 may adjust the flaw priority score of the flaw records A and B to reflect the asset criticality. That is, the flaw correlation engine 304 may modify the flaw priority score of flaw record A to be two times the flaw priority score of the flaw record B for the same flaw_1. In other words, if flaw_1 has a criticality score X, the flaw correlation engine 304 may modify the criticality score of flaw_1 to be 2X to generate a flaw priority score for flaw record A that reflects the very high asset criticality score of computer A associated with flaw record A. One of ordinary skill in the art can understand and appreciate that doubling the criticality score based on asset criticality as described above is an example and is not limiting. That is, the flaw priority scores and/or flaw criticality scores can be modified by any appropriate amount based on any appropriate factors without departing from a broader scope of this disclosure.

The criticality of the flaw and the asset may be represented by a flaw source specific vulnerability score of a flaw, an asset criticality score, an intelligence source specific score of a flaw, and so on. For example, the flaw priority score of each flaw record may be calculated based on Vulnerability Score of the flaw represented by the flaw record, Patch Criticality and Age (endpoint manager), Asset Criticality, Common Vulnerability Scoring System CVSS Score of the flaw represented by the flaw record, and threat intelligence severity, and/or internal compliance due date requirements associated with the flaw represented by the flaw record.

Flaw sources may have the capability of configuring criticality of the asset internally. However, one of ordinary skill in the art can understand and appreciate that the flaw remediation management system of the present disclosure receives/retrieves the asset criticality from disparate external data sources, such as asset inventory databases (e.g., CMDB). In some embodiments, the flaw server 102 may receive and process asset criticality information only from the external data sources; however, in other embodiments, the asset criticality information may receive and process asset criticality information from the external data sources in addition to the asset criticality information from the flaw sources.

Responsive to generating one flaw records and the flaw priority score for each flaw record, the flaw correlation engine 304 forwards the flaw records to the flaw assignment engine 310. The asset owner identification engine 312, the service provider identification engine 314, and the stakeholder identification engine 316 of the flaw assignment engine 310 may identify and assign an asset owner, a service provider, and a stakeholder to each flaw record based on information associated with IT assets from one or more intelligence sources 106 such as, CMDB and Active Directory. Further, information associated with flaws from one or more intelligence sources 106, such as GRC RSAM may be used by the flaw assignment engine 310 to associate additional data, such as exceptions, compliance, and/or Plan of Action and Milestones (PoAM's) with each flaw record. Even though the present disclosure describes that the additional data includes exceptions, compliance, and/or PoAM's associated with the flaw, one of ordinary skill in the art can understand and appreciate that any other data associated with the flaw can be substituted or added to the additional data without departing from a broader scope of the present disclosure. Hereinafter, information associated with the asset owner, stakeholder, and/or service provider and the additional information may be referred to as flaw assignment information.

Further, the flaw correlation engine 304 and/or the flaw assignment engine 310 stores each flaw record in the flaw database 334 along with the flaw priority score and the flaw record information of the flaw record. Accordingly, the flaw database 334 may include, inter alia, a list of asset identifiers, a list of flaw records corresponding to each asset identifier, a flaw priority score associated with each flaw record, and/or flaw assignment information, such as the asset owner, the stakeholder, and/or the service provider associated with the IT asset corresponding to the flaw record. In addition, the flaw database 334 may include remediation ticket information as described in greater detail below.

In addition to the flaw database 334, the flaw server 102 may include a flaw reference database that stores each of the mapping criteria, correlation criteria, the criticality criteria, and/or the grouping criteria. As described above, each criterion may be user configurable to allow for a scalability of the system. That is the user configurable nature of the flaw remediation system allows for accommodating any appropriate number of new flaw sources and/or IT assets to the flaw remediation system without compromising a consistent, effective, and accurate remediation management service offered by the flaw remediation system.

As illustrated in FIG. 3, the flaw server 102 includes a work correlation engine 324 that retrieves the flaw records stored in the flaw database 334 and forwards it to a workflow grouping engine 330. The workflow grouping engine 330 may analyze the received flaw records and group them into one or more work items based on grouping criteria. The grouping criteria may be configurable by a user 110, such as a system administrator. In particular, the grouping criteria may identify flaws that can be remediated together and accordingly group the flaw records corresponding to the identified flaws into the same work item. Each work item may be scoped to a single service provider. In other words, a work item may include flaw records assigned to the same service provider, thereby streamlining the remediation process. However, one of ordinary skill in the art can understand and appreciate that in some embodiments, a work item may include flaw records assigned to different service providers. In certain example embodiments, the flaws that can be remediated together may be determined based on the flaw itself and/or the asset; however, in other example embodiments, the flaws that can be remediated together may be determined based on any other information related to the flaw record, such as, exceptions, compliance, the asset owner, the stakeholder, and/or the service provider. In one example, 20 flaw records associated with 20 respective flaws on a single asset may be grouped together as one work item. In another example, 100 flaw records associated with one flaw on 100 different assets may be grouped together as one work item. In yet another example, 8 flaw records associated with 8 flaws related to one application installed on 15 assets may be grouped together as one work item.

Responsive to grouping the flaw records into work items as described above, the workflow grouping engine 330 may forward the work items to a work prioritization engine 332. Upon receiving the work items, the work prioritization engine 332 may calculate a work priority score for each work item based on one or more factors, such as the flaw priority score of each flaw record in the work item, the number of assets affected by the flaw represented by the flaw record, a length of time for which the flaw has existed in an asset and not been remediated, a recurrence of the flaw on the same asset or a different asset, exceptions and authorizations associated with the flaw, and so on. In particular, the length of time for which the flaw has existed in an asset, the remediation status of the flaw, and/or the recurrence of the flaw on the same asset or a different asset may be determined by the history correlation engine 326. One of ordinary skill in the art can understand and appreciate that the one or more factors mentioned above are not limiting, and any other facts may be used instead of or in addition to the above-mentioned one or more factors to calculate a work priority score without departing from a broader scope of the present disclosure. In one example, the work priority score of a work item may be calculated by a simple operation of adding the flaw priority score of each flaw record in the work item and assigning the sum as the work priority score of the work item. Alternatively, in another example, other simple or complex operations that takes into account other dynamic and subjective factors such as enterprise or business rules, compliance, exceptions and authorizations associated with the flaw, the length of time for which the flaw has existed in an asset and not been remediated, a recurrence of the flaw on the same asset or a different asset, and so on may be used to calculate the work priority score without departing from a broader scope of the present disclosure.

Once the work priority score for each work item is calculated, the work prioritization engine 332 forwards the work items and the work priority score of each work item to a ticketing engine 325. The ticketing engine 325 may compare the work priority score of each work item against a threshold score. On the basis of a result of the comparison, in certain example embodiments, the ticketing engine 325 may generate API calls associated with the ticketing system 108 for creating and assigning a new remediation tickets to a work item, updating an existing remediation ticket assigned to a work item, and/or canceling an existing remediation ticket assigned to a work item. Alternatively, in some example embodiments in which the ticketing system 108 is integral with the flaw server 102, the ticketing engine 325 may be configured to directly create and assign the remediation tickets, update existing remediation tickets, and/or cancel existing remediation tickets. Additionally, once a remediation ticket is created, updated, and/or cancelled, the ticketing engine 325 updates the flaw database to indicate that a status of a remediation ticket assigned to flaw records associated with the work item.

Further, information in the flaw database 334 may be used by the report generation engine 318 to create reports and/or interactive dashboards that indicate information associated with the remediation tickets, and/or various risk and performance metrics associated with the flaw remediation managements system 100 and/or the assets of the IT system. The report generation engine 318 may be configured to grant access to these reports and/or interactive dashboards to one or more users 110 based on authentication of the users 110. Accordingly, the report generation engine 318 may receive user credentials, such as username, password, or any other information that identifies a user. Further, to successfully authenticate the user, the report generation engine 318 may determine if the user identified by the received user credentials has permission to access the reports and/or interactive dashboards created by the report generation 318 engine. Once the report generation engine 318 determines that the user has permission to access the reports and/or interactive dashboards created by the report generation 318 engine, the report generation engine 318 may customize the reports and/or interactive dashboards based on a role of the authenticated user and/or an access level of the authenticated user. For example, a system administrator may be provided with a detailed view of each remediation ticket, flaw record, history, and so on, whereas a senior management team may be provided with an overall view of the security risk associated with the enterprises IT system. Alternatively, the system administrator may be initially provided with the overall view of the security risk associated with the enterprises IT system which can be drilled down, filtered, and/or searched for finer details. However, in said example, such interactive capabilities may be disabled for some users. In other words, the granularity of the content that is included in the report and/or interactive dashboard or is accessible via various drilling down, filtering, and/or searching techniques varies based on a role and/or access level of the authenticated user. Further, responsive to authenticating the user and customizing the report and/or interactive dashboard, the report generation engine 318 may present the report and/or interactive dashboard to the authenticated user, which the user may remotely access via the user's computing device 120.

The operations of the flaw server 102 and the flaw remediation management system 100 are described in greater detail below in association with FIGS. 4-8. Accordingly, turning now to FIGS. 4-8, these figures include flowcharts that illustrate the process of the flaw remediation management system 100. Although specific operations are disclosed in the flowcharts illustrated in FIGS. 4-8, such operations are exemplary. That is, embodiments of the present invention are well suited to performing various other operations or variations of the operations recited in the flowcharts. It is appreciated that the operations in the flowcharts illustrated in FIGS. 4-8 may be performed in an order different than presented, and that not all of the operations in the flowcharts may be performed.

All, or a portion of, the embodiments described by the flowcharts illustrated in FIGS. 4-8 can be implemented using computer-readable and computer-executable instructions which reside, for example, in computer-usable media of a computer system or like device. As described above, certain processes and operations of the present invention are realized, in one embodiment, as a series of instructions (e.g., software programs) that reside within computer readable memory of a computer system and are executed by the processor of the computer system. When executed, the instructions cause the computer system to implement the functionality of the automated payment information system as described below.

Turning to FIG. 4, this figure is a flowchart that illustrates an example method of operation of the flaw server 102 of FIG. 1 in accordance with an example embodiment. In operation 402, the flaw server 102 may receive flaw data from a plurality of flaw sources 104. The plurality of flaw sources 104 may include proprietary and/or commercial flaw identification sources that are configured to identify flaws in one or more assets of an enterprise's IT system. Further, the identified flaws are transmitted as flaw data to the flaw server 102. In certain example embodiments, the plurality of flaw sources 104 may be configured to automatically transmit the flaw data to the flaw server 102. Alternatively, in other example embodiments, the plurality of flaw sources 104 may be configured to transmit the flaw data based on a request from the flaw server 102.

In either case, upon receiving the flaw data, in operation 404, the flaw server 102 analyzes and correlates the flaw data to generate one flaw record per flaw for each asset of the enterprise's IT system based on correlation criteria. The correlation criteria may be configured based on the flaw data itself and/or intelligence information. Accordingly, in operation 404, the flaw server 102 receives intelligence information from a plurality of intelligence sources 106 to enhance or enrich the flaw data. Similar to the flaw sources 104, the plurality of the intelligence sources 106 may be configured to transmit intelligence information to the flaw server 102 either automatically or in response to a request from the flaw server 102. The intelligence information may include, inter alia, publicly available and/or proprietary information related to one or more flaws and/or one or more assets of an IT system.

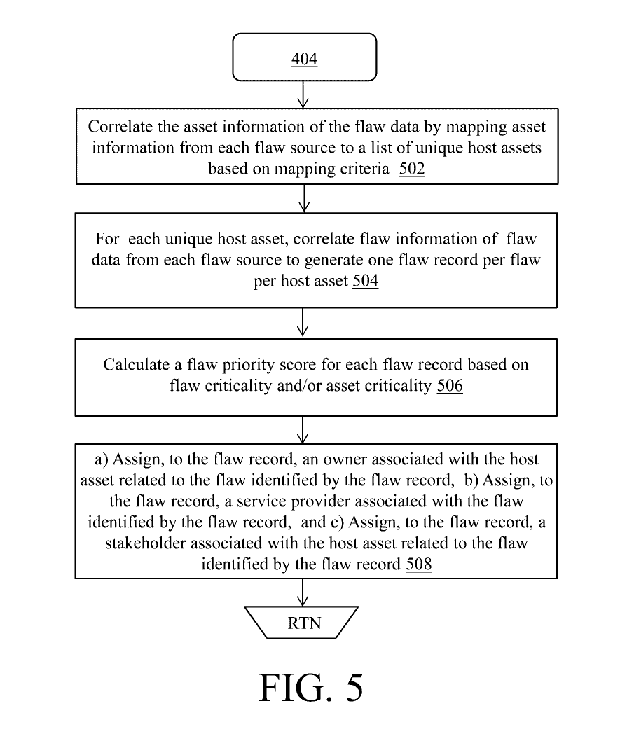

The step of correlating the flaw data to generate the flaw records in operation 404 will be described in greater detail below in association with FIG. 5. Accordingly, turning to FIG. 5, this figure is a flowchart that illustrates an example method of analyzing and correlating flaw data from a plurality of flaw sources to generate one flaw record per flaw per host asset, in accordance with an example embodiment.

In operation 502, the flaw server 102 normalizes and correlates asset information associated with the flaw data. In particular, first, the flaw server 102 normalizes the asset information. Then, the flaw server 102 maps the asset identifiers in the normalized asset information to a master list of asset identifiers (herein interchangeably referred to as ‘master asset identifiers’) that are native to the flaw server 102 based on mapping criteria. In other words, the asset identifiers that are native to the flaw sources are mapped to asset identifiers that are native to the flaw server 102 based on the mapping criteria. The mapping criteria may be configured based on publicly available and/or proprietary information related to one or more assets of an IT system.

Once the asset information is normalized and mapped to a master list of asset identifiers, each data point of the flaw data is associated with the master asset identifier. Then, in operation 504, the flaw server 102 normalizes and correlates the flaw information associated with the flaw data. In certain example embodiments, data points of the flaw data may be separated based on the master asset identifier associated with the data point. Then, for each asset corresponding to the master asset identifier, the flaw server 102 analyzes and compares each data point associated with the asset to identify one or more data points that refer to the same flaw. Upon identifying the one or more data points that refer to the same flaw, the flaw source 102 generates a flaw record that represents the flaw referred to by the one or more data points. Operations 502 and 504 are repeated for each asset to generate one flaw record per flaw for each asset. Each asset may have one or more flaw records.

Responsive to generating flaw records, in operation 506, the flaw server 102 calculates a flaw priority score for each flaw record using criticality criteria that takes into consideration a criticality of the flaw represented by the flaw record and/or a criticality of the asset. In certain example embodiments, the criticality of the flaw and/or the criticality of the asset may be defined using scores assigned to the flaw and/or asset by the flaw sources 104 and/or the intelligence sources 106. For example, each flaw source 104 and intelligence source 106 may assign a vulnerability score to each flaw. Further, sources 104 and 106 may also assign scores that indicate a criticality of an asset. For example, a main server computer in the IT system that affects hundreds of end user computers may have a higher criticality score than an end user computer. The scores assigned by each flaw source 104 and/or intelligence source 106 may vary from each other since the score may be native to the respective source. Accordingly, the flaw server 102 may use any appropriate mathematical and/or logical operations to even out the varying scores and to calculate the flaw priority score that is native to the flaw source 102.

Once the flaw priority score for each flaw record is calculated, in operation 508, the flaw server 102 assigns an asset owner, a stakeholder, and/or a service provider to each flaw record using correlation criteria that is configured based on the flaw data from the flaw sources 104 and/or intelligence information from the intelligence sources 106. In addition, the flaw server 102 can assign business rules, flaw related exceptions and/or remediation information (e.g., PoAM's) to each flaw record. Then, the flaw server 102 returns the flaw records, the flaw priority score of each flaw record, and/or flaw assignment information (exception, compliance, asset owner, stakeholder, service provider, etc.) of the flaw record to operation 406 of FIG. 4.

Returning to FIG. 4, in operation 406, the flaw server 102 stores the flaw records, the flaw priority score of each flaw record, and/or flaw assignment information of the flaw record in the flaw database 334. Additionally, information regarding remediation tickets associated with each flaw record and a status of the remediation tickets may be stored in the flaw database 334 as will be described in greater detail in the following paragraphs.

Responsive to storing the flaw records along with the above-mentioned data associated with each flaw record in the flaw database 334, in operation 408, the work correlation engine 324 of the flaw server 102 retrieves the flaw records and groups them into work items based on grouping criteria. The grouping criteria may be configured based on one or more of the following: the flaw represented by the flaw record, the asset associated with the flaw, the flaw priority score of each flaw record, information associated with the asset owner, information associated with the stakeholder, information associated with the service provider, and/or exceptions associated with the flaw. For example, a plurality of flaw records assigned to the same service provider may be grouped as one work item. In another example, a plurality of flaw records assigned to the same asset may be grouped into one work item. In yet another example, flaw records representing the same flaw across multiple assets may be grouped into one work item. In some examples, a plurality of flaw records associated with the same exception may be grouped into one work item. In certain example embodiments, each work item may be formed such that they may be scoped to one service provider; however, in some example embodiments, a work item may include flaw records that are assigned to different service providers. Even though the present disclosure describes that the grouping criteria may be configured based on one or more of the above-mentioned factors, one of ordinary skill in the art can understand and appreciate that the grouping criteria may take into consideration any other appropriate factors for grouping the flaw records without departing from a broader scope of the present disclosure.

Responsive to grouping the flaw records into work items, in operation 408, the flaw server 102 calculates a work priority score for each work item based on one or more factors, such as the flaw priority score of each flaw record in the work item, the number of assets affected by the flaw represented by the flaw record, a length of time for which the flaw has existed in an asset and not been remediated, a recurrence of the flaw on the same asset or a different asset, exceptions and authorizations associated with the flaw, and so on. One of ordinary skill in the art can understand and appreciate that the one or more factors mentioned above are not limiting. That is, the flaw server 102 may use any other appropriate factors instead of or in addition to the above-mentioned one or more factors to calculate the work priority score.

In one example embodiment, the flaw server 102 may calculate the work priority score of each work item by adding the flaw priority scores of each flaw record in the respective work item. However, one of ordinary skill in the art can understand and appreciate that the work priority score calculation is not limited to the above-included example and that any other calculation method may be used without departing from a broader scope of the present disclosure. For example, if a flaw record in the work item represents a recurring flaw or if there is an exception associated with the flaw, then, the work priority score may be modified to indicate the recurring flaw and/or the exception, respectively.

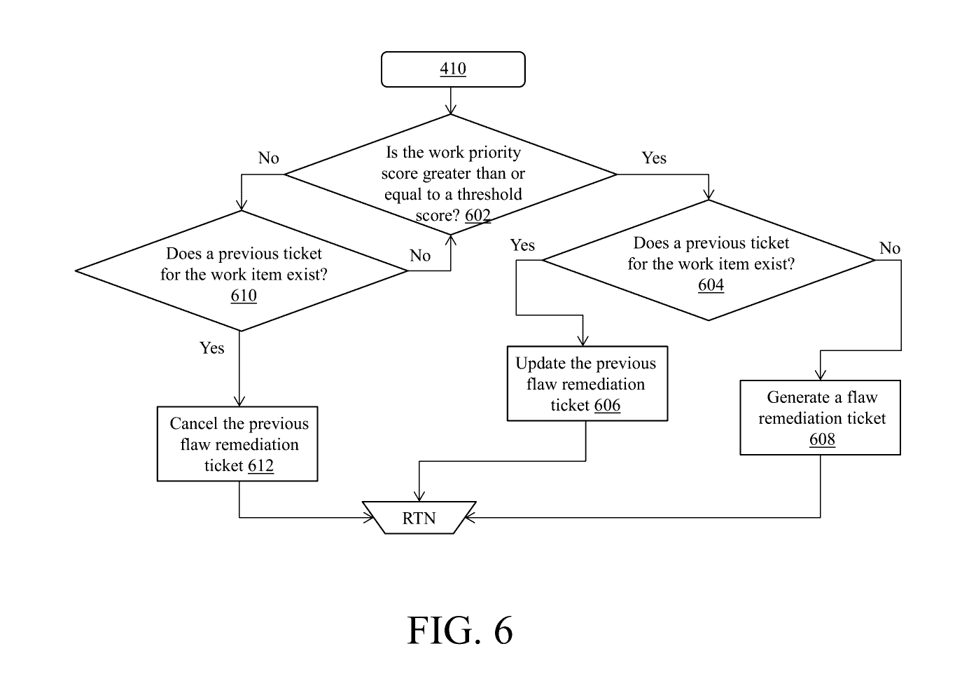

Responsive to calculating the work priority score for each work item, in operation 410, the flaw server 102 may directly or indirectly generate and manage remediation tickets for each work item based on the work priority score of the respective work item. The step of generating and managing the remediation tickets will be described in greater detail below in association with FIG. 6.

Turning to FIG. 6, this figure is a flowchart that illustrates an example method of grouping flaw records into work items and managing remediation tickets associated with each work item in accordance with an example embodiment. In operation 602, the flaw server 102 compares the work priority score of a work item with a threshold score. If the work priority score is greater than or equal to the threshold score, in operation 604, the flaw server 102 checks if a remediation ticket has been previously created for the work item. If a remediation ticket has been previously created, in operation 606, the flaw server 102 generates an API call requesting a ticketing system 108 to provide an update on a current status of the previously created remediation ticket. Responsive to receiving the current status of the remediation ticket the flaw server 102 may update the flaw database 334 with the current status of the remediation ticket. However, if a remediation ticket has not been created, then, in operation 608, the flaw server 102 generates an API call requesting the ticketing system 108 to create a new remediation ticket for the work item. Further, the flaw server 102 updates the flaw database 334 with information about the newly created remediation ticket for the work item.

Returning to operation 602, if the work priority score of the work item is less than the threshold score, the flaw server 102 proceeds to operation 610. In operation 610, the flaw server 102 checks if a remediation ticket has been previously created for the work item. If a remediation ticket has been previously created, in operation 612, the flaw server 102 generates an API call requesting the ticketing system 108 to cancel the previously created remediation ticket. Upon receiving a confirmation from the ticketing system 108 that the remediation ticket has been cancelled, the flaw server 102 updates the flaw database 334 to reflect a cancellation of the remediation ticket associated with the work item.

In certain example embodiments, the work priority score of a work item may be updated continuously or at discrete time intervals based on the flaw data from the plurality of flaw sources 104 and/or intelligence information from the plurality of intelligence sources 106. For example, a work item may include flaw records for flaws 1-4 reported by the plurality of flaw sources 104. Accordingly, a work priority score of the work item may be calculated based on flaws 1-4. Later, flaws 1 and 2 may be remediated and the plurality of flaw sources 104 stop reporting flaws 1 and 2. In response, the work item is updated to remove flaw records associated with flaws 1 and 2. Further, the work priority score of the work item may be modified to reflect the removal of flaws 1 and 2. In said example, if the modified work priority score of the work item falls below the threshold score, a remediation ticket associated with the work item may be cancelled. In another example, the work priority score of a work item may change based on an exception or a business rule associated with a flaw. One of ordinary skill in the art can understand and appreciate that the above-mentioned examples of updating the work priority score are not limiting, and any other appropriate factors may be used to update the work priority score without departing from a broader scope of the present disclosure.

Returning to operation 610, if a remediation ticket has not been created for the work item, then, the flaw server 102 returns to operation 602 and waits till the work priority score of the work item is greater than or equal to the threshold score. Once the work priority score is greater than or equal to the threshold score, the flaw server 102 instructs the ticketing system 108 to create, update, and/or cancel remediation tickets as described above. Responsive to creating, updating, and/or canceling remediation tickets, the flaw server 102 returns to operation 410 of FIG. 4 and the process of flaw remediation management ends. Alternatively, responsive to operation 410, the flaw server 102 returns to operation 402 to newly receive flaw data and repeat the above mentioned steps based on the newly received flaw data.

Even though the present disclosure describes that the flaw server 102 generates API calls requesting the ticketing system 108 to perform various ticketing operations, one of ordinary skill in the art can understand and appreciate that in some embodiments, the ticketing system 108 may be integral with the flaw server 102 and the ticketing engine 325 of the flaw server 102 may directly create, update, and/or cancel remediation tickets without departing from a broader scope of the present disclosure. Further, in addition to creating, updating, and cancelling remediation tickets, the ticketing system 108 may be configured to notify one or more users 110 regarding the various ticketing operations, escalate a remediation ticket, and/or remind a user 110 (e.g., service provider) about a remediation ticket based on a service level agreement.

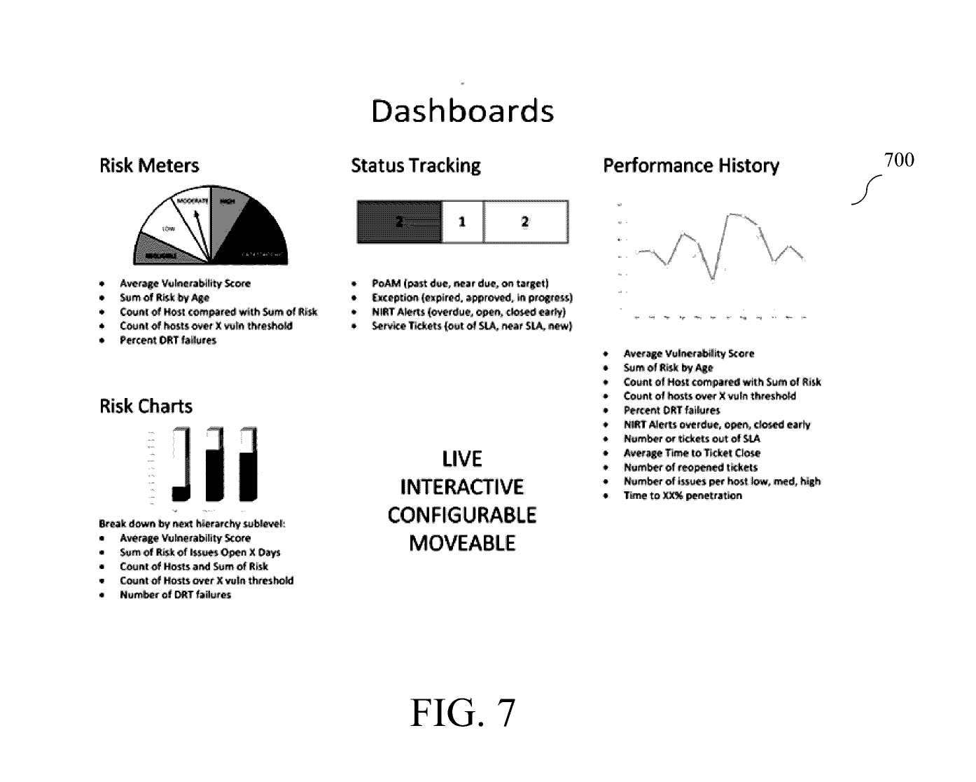

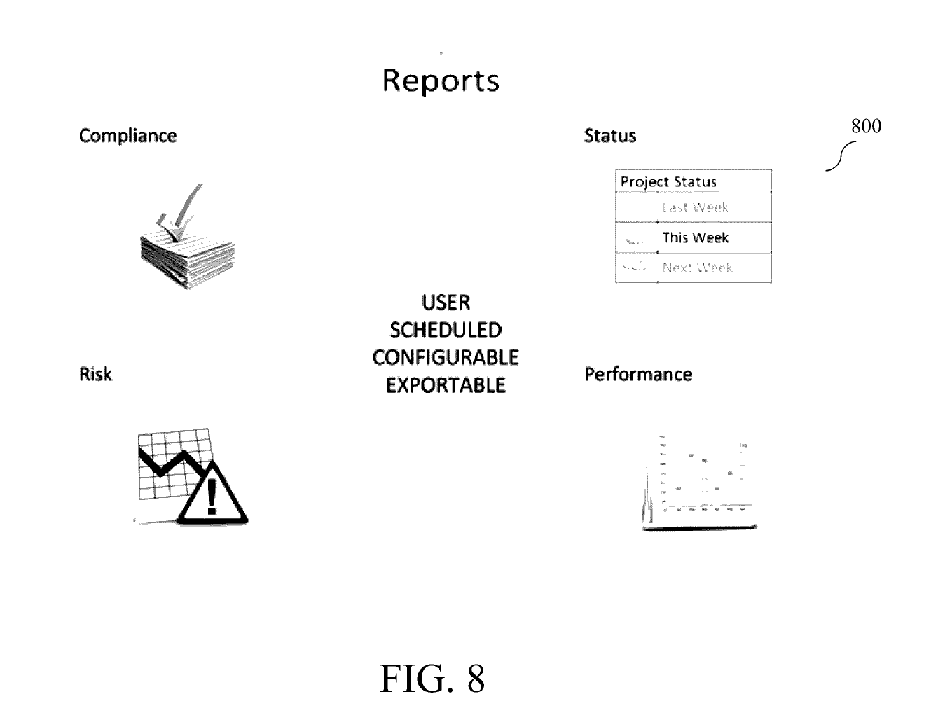

Returning to FIG. 4, in addition to generating and/or managing the remediation tickets, in operation 412, the flaw server 102 generates a remediation management dashboard 700 as illustrated in FIG. 7 and/or one or more reports 800 as illustrated in FIG. 8. The dashboard 700 and/or reports 800 may be generated based on information stored in the flaw database 334 and/or data received from the flaw sources 104 (flaw data) and/or the intelligence sources 106 (intelligence information). In particular, the dashboard 700 and/or reports 800 may provide various performance and risk metrics associated with the flaw remediation management system as illustrated in FIGS. 7 and 8. However, one of ordinary skill in the art can understand and appreciate that the metrics and data included in the dashboard 700 and/or reports 800 illustrated in FIGS. 7 and 8 are examples and are not limiting. That is the dashboard and/or reports can include any appropriate data ranging from simple textual presentation of the data stored in the flaw database, flaw data, and/or intelligence data to a representation of any complex operations (e.g., analytical, statistical, risk projections, etc.) on the data stored in the flaw database, flaw data, and/or intelligence data.

Further, as illustrated in FIG. 7, the dashboard 700 may be dynamically updated as and when new data associated with the flaw remediation management system is available at the flaw server 102. Furthermore, the dashboard 700 may be interactive. For example, the dashboard 700 may have drill down features, filtering features, search features, and so on that allows a user to interact with the dashboard and the data presented via the dashboard. Further, the dashboard 800 may be configurable as desired by the user 110. The configuration and/or interactive features of the dashboard may be provided based on a role or access level of a user 110. For example, some of the interactive features and configuration features may be masked or disabled for a service provide user, whereas a system administrator may be provided with a full access to all the features.

Similarly, as illustrated in FIG. 8, the reports 800 may be interactive and configurable as well. In certain example embodiments, the reports 800 may be presented in an electronic format that is printable, downloadable, exportable, and/or transferable between users 110. However, in other example embodiments, any other appropriate format may be used to present the reports 800.

The flaw server 102 may grant access to the dashboard 700 and/or reports 800 based on successful authentication of the user 110. Once the user 110 is successfully authenticated, in operation 412, the flaw server 102 may identify an access level or role of the user 110. Further, the flaw server 102 filters and/or customizes data included in the dashboard 800 and/or reports 800 presented to the user 110 based on the access level or role of the user 110. The customized dashboard and/or reports may be accessed by the user 110 via the user's computing device 120.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structures and methods may be embodied using transistors, logic gates, and electrical circuits (e.g., application specific integrated (ASIC) circuitry and/or in Digital Signal Processor (DSP) circuitry).

The terms “invention,” “the invention,” “this invention,” and “the present invention,” as used herein, intend to refer broadly to all disclosed subject matter and teaching, and recitations containing these terms should not be misconstrued as limiting the subject matter taught herein or to limit the meaning or scope of the claims. From the description of the exemplary embodiments, equivalents of the elements shown therein will suggest themselves to those skilled in the art, and ways of constructing other embodiments of the present invention will appear to practitioners of the art. Therefore, the scope of the present invention is to be limited only by the claims that follow.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1) A flaw remediation management system comprising:
a plurality of disparate flaw identification sources, each flaw identification source configured to monitor and identify flaws in one or more assets associated with an information technology system;
a computer network; and
a flaw remediation management server computer communicatively coupled to the plurality of disparate flaw identification sources via the computer network, the flaw remediation management server computer configured to:
receive flaw data from the plurality of disparate flaw identification sources, the flaw data representative of the flaws associated with the one or more assets;
for each asset of the one or more assets, generate one flaw record per flaw of the respective asset by correlating the flaw data across each flaw identification source of the plurality of disparate flaw identification sources;
group the generated flaw records of the one or more assets into work items based on grouping criteria, each work item comprising one or more of the generated flaw records of the one or more assets;
for each of the work items,
calculate a work priority score, and
generate and manage a flaw remediation ticket based on the work priority score; and
generate and output an interactive flaw remediation management report based on the generated flaw records.

2) The flaw remediation management system of claim 1:
wherein the flaw remediation management server computer is configured to enrich the flaw data using intelligence information from a plurality of flaw intelligence sources, and
wherein the intelligence information includes at least one of information associated with the flaws of the one or more assets, information associated with the one or more assets, security policies, exceptions, and security compliance information.

3) The system of claim 1, wherein to generate the one flaw record per flaw of the respective asset, the flaw remediation management server computer is configured to:
normalize asset information of the flaw data; and
map asset identifiers of the normalized asset information to a master list of asset identifiers native to the flaw remediation management server computer based on mapping criteria.

4) The system of claim 1, wherein to generate the one flaw record per flaw of the respective asset, the flaw remediation management server computer is configured to:
identify one or more data points of the flaw data that are associated with an asset of the one or more assets;
analyze each of the one or more data points to identify a set of data points from the one or more data points that represent one flaw; and
create a flaw record for the one flaw represented by the identified set of data points.

5) The system of claim 1,
wherein the flaw remediation management server computer is configured to calculate a flaw priority score for each of the generated flaw records of the one or more assets, and
wherein the flaw priority score of the flaw record is calculated based on at least one of a criticality of the flaw represented by the respective flaw record and a criticality of the asset associated with the respective flaw record.

6) The system of claim 1, wherein the flaw remediation management server computer is configured to assign an asset owner, a stakeholder, and/or a service provider to each of the generated flaw records of the one or more assets.

7) The system of claim 1, wherein the work priority score of each of the work items is generated based on a flaw priority score of each of the one or more flaw records included in the respective work item.

8) The system of claim 1, wherein to generate and manage the remediation ticket of the work item, the flaw remediation management server computer is configured to compare the work priority score of the work item against a threshold score.

9) The system of claim 8, wherein when the work priority score is less than the threshold score, the flaw remediation management server computer is configured to cancel the remediation ticket.

10) The system of claim 8, wherein when the work priority score is greater than or equal to the threshold score, the flaw remediation management server computer is configured to create or update the remediation ticket.

11) A flaw remediation management server computer, comprising:
a flaw correlation engine configured to:
receive flaw data from a plurality of disparate flaw identification sources, wherein the flaw data representing flaws associated with one or more assets of an information technology system,
for each asset of the one or more assets, generate one flaw record per flaw of the respective asset by correlating the flaw data across each flaw identification source of the plurality of disparate flaw identification sources, and
calculate a flaw priority score for each of the generated flaw records of the one or more assets based on at least one of a criticality of a flaw represented by the respective flaw record and a criticality of an asset associated with the respective flaw record; and
a flaw correlation engine configured to:
group the generated flaw records of the one or more assets into work items based on grouping criteria, and
for each work item,
calculate a work priority score for each of the work items based on the flaw priority score of the flaw records included in the respective work item, and
generate instructions for managing a flaw remediation ticket associated with the respective work item based on the work priority score.

12) The flaw remediation management server computer of claim 11, wherein the flaw correlation engine is configured to transmit the instructions for managing the flaw remediation ticket to a ticketing system that is communicatively coupled to the flaw remediation management server, and wherein the ticketing system is configured to create, update, and/or cancel the flaw remediation ticket.

13) The flaw remediation management server computer of claim 11, wherein the generated flaw records of the one or more assets and their respective flaw priority scores are stored in a flaw database.

14) The flaw remediation management server computer of claim 11, wherein to generate the one flaw record per flaw of the respective asset, the flaw correlation engine is configured to:
identify one or more data points of the flaw data that are associated with an asset of the one or more assets;
analyze each of the one or more data points to identify a set of data points from the one or more data points that represent one flaw; and
create a flaw record for the one flaw represented by the identified set of data points.

15) The flaw remediation management server computer of claim 11, further comprising: a report generation engine configured to generate and output an interactive flaw remediation management report based on the generated flaw records.

16) The flaw remediation management server computer of claim 15, wherein the flaw remediation management report includes an interactive dashboard.

17) The flaw remediation management server computer of claim 15, wherein the flaw remediation management report includes an electronic report.

18) A method of flaw remediation management server computer for managing flaw remediation in an information technology system having one or more assets, the method comprising:
correlating, by a flaw correlation engine of the flaw remediation management server computer, flaw data received from a plurality of disparate flaw identification sources to generate, for each asset, one flaw record per flaw of the respective asset;
grouping, by a work correlation engine of the flaw remediation management server computer, the generated flaw records of the one or more assets into one or more work items;
calculate, by the work correlation engine, a work priority score for each work item of the one or more work items based on a flaw priority score of each flaw record of the work item; and
for each work item, generating and managing, by the work correlation engine, a flaw remediation ticket based on the work priority score of the respective work item.

19) The method of claim 18, further comprising generating and outputting, by a report generation engine of the flaw remediation management server computer, an interactive flaw remediation management report based on the generated flaw records.

20) The method of claim 18, wherein the flaw priority score of the flaw record is calculated by the flaw correlation engine based on at least one of a criticality of a flaw represented by the flaw record and a criticality of the asset associated with the flaw record.
